(19) United States
(12) Patent Application Publication
(10) Pub. No.: US 2021/0002878 A1
(43) Pub. Date: Jan. 7, 2021

(54) LYNNE GRINDER

(71) Applicant: Andrew Kaminski, Gaithersburg, MD (US)

(72) Inventor: Andrew Kaminski, Gaithersburg, MD (US)

(21) Appl. No.: 16/503,959

(22) Filed: Jul. 5, 2019

(51) Int. Cl. E03C 1/266; B02C 25/00; B02C 23/08

(52) U.S. Cl. CPC E03C 1/2665; B02C 23/08; B02C 25/00

(57) ABSTRACT

A garbage disposal for saving space under a sink. The garbage disposal is a small, compact garbage disposal that takes less space under a sink. The garbage disposal further has a compact electric motor for conserving energy. The garbage disposal has a universal adaptor coupled to a drain in the sink. The universal adaptor is coupled to a receiving pipe for receiving waste and water. The receiving pipe has a plurality of magnets that are for removing metal from the waste. The garbage disposal has a garbage grinder coupled to the receiving pipe, where the waste is ground by one or more grinding steel blades. The garbage disposal has a motor that is communicatively coupled to grinding steel blades by a power transfer shaft.

### FIELD OF THE INVENTION

This invention relates to garbage disposal. More particularly, it relates to a very small compact garbage disposal.

### BACKGROUND

A garbage disposal unit (also known as a waste disposal unit, garbage disposer, or in Canadian English a garburator) is a device, usually electrically powered, installed under a kitchen sink between the sink's drain and the trap. The disposal unit shreds food waste into pieces small enough—generally less than 2 mm (0.079 in)—to pass through plumbing.

Garbage disposal units are used extensively in United States households, but are far less common elsewhere in the world.

Most garbage disposal unites have a high-torque, insulated electric motor, usually rated at 250-750 W (⅓-1 hp) for a domestic unit, spins a circular turntable mounted horizontally above it. Induction motors rotate at 1,400-1,800 rpm and have a range of starting torques, depending on the method of starting used. The added weight and size of induction motors may be of concern, depending on the available installation space and construction of the sink bowl.

Universal motors, also known as series-wound motors, rotate at higher speeds, have high starting torque, and are usually lighter, but are noisier than induction motors, partially due to the higher speeds and partially because the commutator brushes rub on the slotted commutator. Inside the grinding chamber there is a rotating metal turntable onto which the food waste drops. Two swiveling metal impellers mounted on top of the plate near the edge then fling the food waste against the grind ring repeatedly. Sharp cutting edges in the grind ring break down the waste until it is small enough to pass through openings in the ring, whereupon it is flushed down the drain.

Usually, there is a partial rubber closure, known as a splashguard, on the top of the disposal unit to prevent food waste from flying back up out of the grinding chamber. It may also be used to attenuate noise from the grinding chamber for quieter operation.

There are two main types of garbage disposers—continuous feed and batch feed. Continuous feed models are used by feeding in waste after being started and are more common. Batch feed units are used by placing waste inside the unit before being started. These types of units are started by placing a specially designed cover over the opening. Some covers manipulate a mechanical switch while others allow magnets in the cover to align with magnets in the unit. Small slits in the cover allow water to flow through. Batch feed models are considered safer, since the top of the disposal is covered during operation, preventing foreign objects from falling in.

Waste disposal units may jam, but can usually be cleared either by forcing the turntable round from above or by turning the motor using a hex-key wrench inserted into the motor shaft from below. Especially hard objects accidentally or deliberately introduced, such as metal cutlery, can damage the waste disposal unit and become damaged themselves, although recent advances, such as swivel impellers, have been made to minimize such damage. More problematic are drain blockages caused by shredded waste that is fibrous, e.g., artichoke leaves, or starchy, e.g., potato peelings.

Some higher-end units have an automatic reversing jam clearing feature. By using a slightly more-complicated centrifugal starting switch, the split-phase motor rotates in the opposite direction from the previous run each time it is started. This can clear minor jams, but is claimed to be unnecessary by some manufacturers: Since the early sixties, many disposal units have utilized swivel impellers which make reversing unnecessary.

Some other kinds of garbage disposal units are powered by water pressure, rather than electricity. Instead of the turntable and grind ring described above, this alternative design has a water-powered unit with an oscillating piston with blades attached to chop the waste into fine pieces. Because of this cutting action, they can handle fibrous waste. Water-powered units take longer than electric ones for a given amount of waste and need fairly high-water pressure to function properly.

Garbage disposals take up a lot of space under a sink that most wish they could use for storage. Therefore, there is a need for a garbage disposal unit that will take up less space, but still be as powerful and successful in the grinding and removal of garbage.

### BRIEF DESCRIPTION OF THE DRAWINGS

FIG. 1 is an illustrated view of an exemplary garbage disposal unit.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

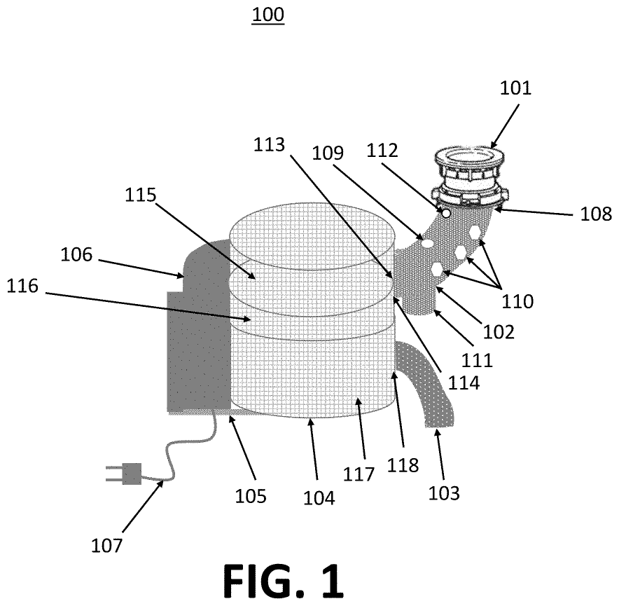

Referring to FIG. 1, a garbage disposal 100 for increasing the space available under a sink is presented. The garbage disposal 100 is a small, compact garbage disposal that takes less space under a sink. The garbage disposal 100 further has a compact electric motor for conserving energy.

The garbage disposal 100 has a universal adaptor 101, receiving pipe 102, a drain pipe 103, a garbage grinder 104, an electric motor 105, a power shaft 105, a motor 106 and a power cord 107. The garbage disposal 100 may be configured to allow access for the retrieval of jewelry or other precious items that become misplaced.

The universal adaptor 101 is coupled to a drain of a sink for receiving the garbage and water to dispose of the waste. The universal adaptor 101 is a generally common adaptor for sink drains and for garbage disposals. The universal adapter 101 is further coupled to a receiving end 108 of the receiving pipe 102.

The receiving pipe 102 is useful for receiving the waste disposed of in the sink and directing it to the garbage grinder 104. The receiving pipe 102 preferably has a “u” shape, but may be straight or other shapes. The receiving pipe 102 is preferably made of PVC, but may be made of other material such as metal, high-hensity polyethylene (HDPE), etc. The receiving pipe 102 preferably has a two (2) inch diameter, but may have other diameter measurements as desired. The receiving pipe has a motion sensor 109, one or more magnets 110, a debris access port 111, a light 112 and an expelling port 113.

The motion sensor 109 detects the presence and movement of content, either water or garbage, in the receiving pipe 102. The motion sensor 109 once detecting movement of the content, the motion sensor 109 sends a message to engage the motor 106 such that the garbage grinder 104 is activated. When the motion sensor 109 detects no movement, then the motion sensor 109.

When the garbage disposal 100 is active the light 112 is lit. The lamp 112 is preferably an LED lamp, but may be other types of lights such as penlight, colored light, LCD, etc.

The one or more magnets 110 are useful for keeping metals, such as utensils, knives, spoons, forks, or perhaps jewelry, that are contained in the garbage taken into the receiving pipe 102 from going through and potentially causing damage to the garbage grinder 104. The one or more magnets are preferably one-half (½) pound fixed metal magnets, but may be other types of magnets of the strength and ability to removed the metal found in the garbage.

The debris access port 111 is a port from the receiving pipe 102. The debris access port 111 preferably has a two (2) inch diameter, but the diameter may be as desired and consistent with the diameter of the receiving pipe 102. The debris access port 111 is useful for allowing an outlet for garbage that may blocking the intake of garbage.

The expelling port 113 of the receiving pipe 102 is coupled to the garbage grinder 104 at a receiving port 114.

The garbage grinder 104 has the receiving port 114, a top cup 115, a middle union 116, a bottom cup 117 and an output port 118. The garbage grinder 104 receives contents from the receiving pipe 102 and grinds (in some cases liquifies) the contents to be disposed of through the drain hose 103. The drain hose 103 may also be configured as a pipe.

The top cup 115 is preferably a three by three (3) inch PVC chamber. The top cup 115 works as a refuse collecting chamber.

The top cup 116 is coupled to the middle union 116. The middle union is a three by three inch (3×3) PVC chamber. The middle union 116 is useful for keeping the top cup 115 and the bottom cup 117 together and works as a quick disconnect for servicing the garbage grinder 104.

The bottom cup 117 is a three by three (3×3) inch chamber. The bottom cup 118 is useful for receiving the refuse from the top cup 115 and grinding the refuse. The bottom cup 117 holds grinding steel blades (not shown) and allows the water to be drained. The water is drained through the output port 118. The grinding steel blades spins at a high velocity reducing common household food leftovers to a liquid mush for easy draining and preventing possible clogs in pipes insuring proper water flow from the sink to a city sewer or cesspool.

The water drained through the output port 118 of the garbage grinder 104 is received at the drain pipe 103. The drain pipe 103 is preferably flexible but may be static, etc. The drain pipe 103 is preferably one inch in diameter, but may be other diameters. The drain pipe 103 is coupled to a sewer pipe for disposal of the water to a sewer or cesspool.

The garbage grinder 104 is powered by the motor 106. The motor 106 is preferably electric. The motor 106 is preferably a two-hundred fifty (250) watt, three and thirty-five one-thousands (0.335) horse power, two-thousand (2,000) RPM, four by three (4×3) inch motor. The motor 104 is typically set on a horizontal position thus saving space while delivering a powerful output to the grinding steel blades.

The motor 106 is coupled to a power transfer shaft 105. The power transfer shaft is preferably four (4) inches in length, but may be other lengths as desired. The power transfer shaft 105 is preferably made of a metal. The power transfer shaft 105 preferably has a ninety (90) degree angle. The power transfer shaft 105 transfers the energy from the motor 106 to the grinding steel blades.

The motor 106 is coupled to a power source by the power cord 107. The power source is preferably a battery, but may be other types of power sources such as AC/DC, solar, wind turbine, water turbine, etc.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A garbage disposal for saving space under a sink, garbage disposal comprising:
a universal adaptor, the universal adaptor coupled to a drain in the sink;
a receiving pipe, the receiving pipe coupled to the universal adapter for receiving waste and water;
a plurality of magnets, the plurality of magnets coupled to the receiving pipe, and wherein the plurality of magnets being for removing metal from the waste;
a garbage grinder, the garbage grinder coupled to the receiving pipe, wherein the waste is ground by one or more grinding steel blades; and
a motor, the motor communicative coupled to the grinding steel blades by a power transfer shaft.

2. The garbage disposal of claim 1, further comprising;
a motion sensor, the motion sensor being for detecting motion within the receiving pipe; and
The motion sensor sending an order to turn activate the motor.

3. The garbage disposal of claim 2, further comprising
A light, the light being coupled to the receiving pipe, and wherein the light being for giving visual notice of the motor being activated.

4. The garbage disposal of claim 3, wherein the light being LED.

5. The garbage disposal of claim 1, wherein the garbage grinder further comprising:
a top cup, the top cup for collecting the waste;
a middle union, the middle union for keeping the top cup and a bottom cup together; and
the bottom cup, the bottom cup having the grinding steel blades for grinding the waste.

6. The garbage disposal of claim 1, wherein the motor being two-hundred fifty (250) watts.

7. The garbage disposal of claim 1, wherein the motor being three hundred thirty-five thousands (0.335) horsepower.

8. The garbage disposal of claim 1, wherein the motor being two-thousand (2,000) RPM.

9. The garbage disposal of claim 1, wherein the motor being four by three (4×3) inches.

10. The garbage disposal of claim 1, wherein the receiving pipe being made of PVC.

11. The garbage disposal of claim 1, wherein the drain hose being flexible.

12. The garbage disposal of claim 1, wherein the drain hose being one (1) inch in diameter.

13. The garbage disposal of claim 1, wherein the receiving pipe having a diameter of two (2) inches.

14. The garbage disposal of claim 1, wherein the one or more magnets being one-half (½) pound fixed metal magnets.

15. The garbage disposal of claim 1, wherein the motor being coupled to a power source by a power cord.

16. The garbage disposal of claim 15, wherein the power source being a battery.
